(19) United States
(12) Patent Application Publication
(10) Pub. No.: US 2025/0209129 A1
(43) Pub. Date: Jun. 26, 2025

(54) INFORMATION PROCESSING APPARATUS

(71) Applicant: CANON KABUSHIKI KAISHA, Tokyo (JP)

(72) Inventor: MASAHIKO KONO, Kanagawa (JP)

(21) Appl. No.: 18/986,010

(22) Filed: Dec. 18, 2024

(30) Foreign Application Priority Data
Dec. 22, 2023 (JP) 2023-216512

(51) Int. Cl. G06F 16/957

(52) U.S. Cl. CPC G06F 16/9577

(57) ABSTRACT

An information processing apparatus that provides a rendering result for a web page to a client based on a request from the client, includes a storing unit configured to store the rendering result in either a first database or a second database different from the first database to provide the rendering result to the client and a selection unit configured to select a database to be used as a storage destination of the rendering result by the storing unit, based on first information and second information, the first information being about a duration between the request from the client and provision of the rendering result to the client by use of the first database, and the second information being about a duration between the request from the client and provision of the rendering result to the client by use of the second database.

### BACKGROUND

### Field of the Disclosure

The present disclosure relates to an information processing apparatus.

### Description of the Related Art

Japanese Patent No. 4326836 discusses a thin client system. In the system, thin client terminals which are low-cost computers having a minimal function such as a screen display function and an input function are distributed to staff members, and a server centrally manages a resource such as application software.

In Japanese Patent No. 4326836, an issue that exists in the thin client system is described. According to the description, a duration of communication time between the thin client terminal and the server affects display in the thin client terminal.

To solve such an issue, Japanese Patent No. 4326836 discusses arrangement of a relay device between the thin client terminal and the server to enhance efficiency of display in the thin client terminal.

In recent years, meanwhile, an application has become executable on a cloud service. Even for the equipment that does not have a high-performance browsing function, the equipment can cause processing to be performed by an application on the cloud service to receive a result of the processing performed by the application.

For example, a technique for rendering a screen by using a hypertext markup language (HTML) (https://html.spec.whatwg.org) is known. An application that processes the HTML is called a browser, and the browser performs rendering based on an HTML specification.

These browsers that are executed in an application execution environment of the cloud service are called cloud browsers.

The cloud browser performs rendering in response to a rendering request from equipment having no high-performance browsing function, and then stores a rendering result in a database in the same cloud service.

Subsequently, the cloud browser transmits a uniform resource locator (URL) for an access to the stored rendering result to the equipment. Upon receipt of the URL, the equipment acquires the rendering result from the database of a storage destination, and displays the acquired rendering result on a screen of the equipment.

In the cloud service, a plurality of servers sharing one database forms one server group, and such server groups are each disposed in different regions.

Each of the server groups provides a service such as application execution environment and a database in a corresponding region.

Accordingly, there is a plurality of server groups in the cloud service. Since such server groups are arranged in different regions, one server group may be arranged near a piece of equipment, whereas another server group may be arranged away from the equipment.

In a case where a cloud browser that performs rendering in response to a request from a piece of equipment is provided by a cloud server in a server group away from the equipment, a rendering result is stored in a database in the distant server group to which the cloud server belongs.

As a result, the equipment acquires the rendering result from the database in the distant server group. In a case where a communication environment is poor, acquisition of the rendering result may take time, and display of the rendering result in the equipment may take time.

The technique discussed in Japanese Patent No. 4326836 is set based on the premise that the thin client terminal and the server correspond to each other on one-on-one basis. Consequently, in a case where there is a plurality of server groups, application of such a technique is difficult.

### SUMMARY

Embodiments of the present disclosure have been made in view of such a situation described above, and are directed to an information processing apparatus that provides a rendering result to a client at high speed even if there is a plurality of server groups.

Embodiments of the present disclosure include the following configurations to achieve the aforementioned objective.

According to embodiments of the present disclosure, an information processing apparatus that provides a rendering result for a web page to a client based on a request from the client, includes a storing unit configured to store the rendering result in either a first database or a second database different from the first database to provide the rendering result to the client and a selection unit configured to select a database to be used as a storage destination of the rendering result by the storing unit, based on first information and second information, the first information being about a duration between the request from the client and provision of the rendering result to the client by use of the first database, and the second information being about a duration between the request from the client and provision of the rendering result to the client by use of the second database.

Further features of the present disclosure will become apparent from the following description of exemplary embodiments with reference to the attached drawings.

### BRIEF DESCRIPTION OF THE DRAWINGS

FIG. 1 is a diagram illustrating a relation between a piece of equipment and server groups according to a first exemplary embodiment.

FIG. 2 is a diagram illustrating a general configuration of a cloud server according to the first exemplary embodiment.

FIG. 3 is a flowchart illustrating an operation performed by the cloud server according to the first exemplary embodiment.

FIG. 4 is a diagram illustrating communication speeds described in the flowchart illustrated in FIG. 3.

FIG. 5 is a diagram illustrating communication times described in the flowchart illustrated in FIG. 3.

FIG. 6 is a diagram illustrating an example of a hypertext markup language (HTML) to be acquired to perform rendering according to the first exemplary embodiment.

FIG. 7 is a diagram illustrating a rendering result based on the HTML illustrated in FIG. 6.

FIG. 8 is a flowchart illustrating an operation performed by a cloud server according to a second exemplary embodiment.

### DESCRIPTION OF THE EMBODIMENTS

Embodiments (hereinafter referred to as “exemplary embodiments”) of the present disclosure are hereinafter described in detail with reference to the accompanying drawings.

However, it is to be understood that the following exemplary embodiments are not intended to limit the scope of the present disclosure.

Not all of the combinations of the aspects that are described in the following exemplary embodiments are necessarily required with respect to an issue to be solved by the present disclosure.

The same reference numerals or codes are allocated to elements having the same function throughout the description of the exemplary embodiments.

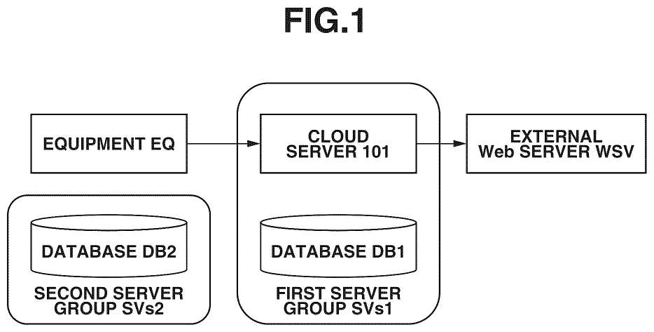

FIG. 1 is a diagram illustrating a relation between a piece of equipment EQ and server groups according to a first exemplary embodiment.

Although a first server group SVs1 illustrated in FIG. 1 includes a plurality of cloud servers that share a single database DB1, only a cloud server 101 out of the plurality of cloud servers is illustrated in FIG. 1. The cloud server 101 is one example of an information processing apparatus according to the present exemplary embodiment.

A second server group SVs2 illustrated in FIG. 1 also includes a plurality of cloud servers that shares a single database DB2. However, only the database DB2 is illustrated in FIG. 1 for the sake of clarity.

The equipment EQ is, for example, a printer, a personal computer (PC), a laptop PC, or a digitizing tablet, and does not have a high-performance browsing function. The equipment EQ is an example of a client according to the present exemplary embodiment.

FIG. 1 illustrates a case where the equipment EQ issues a rendering request to perform rendering with respect to an external world wide web (Web) server WSV to the cloud server 101, as one example of a request from a client.

In the present exemplary embodiment, the equipment EQ is disposed closer to the second server group SVs2 than the equipment EQ is to the first server group SVs1.

For example, the first server group SVs1 is installed in Japan, the second server group SVs2 is installed in the United States of America, and the equipment EQ is disposed in the United States of America.

In such a case, depending on the communication environment, it may be better to store a result of the rendering performed by the cloud server 101 in the database DB1 to quickly display the rendering result on the equipment EQ, while in other cases, it may be better to store the result in the database DB2.

In such a situation, in the present exemplary embodiment, it is possible to appropriately select between the database DB1 and the database DB2 to use the one that allows the equipment EQ to display a rendering result faster. Such selection is described in detail below.

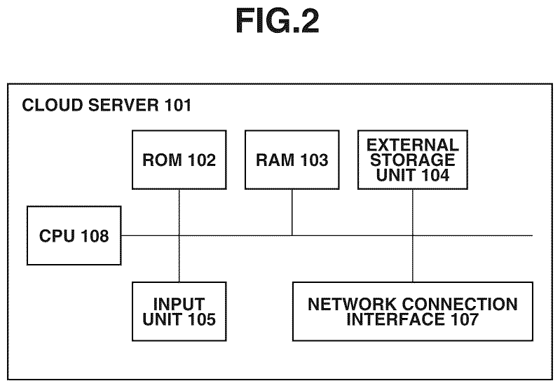

Initially, the cloud server 101 is described with reference to FIG. 2 that illustrates a general configuration of the cloud server 101 according to the first exemplary embodiment.

As illustrated in FIG. 2, the cloud server 101 includes a central processing unit (CPU) 108, a read only memory (ROM) 102, a random access memory (RAM) 103, an input unit 105, an external storage unit 104, and a network connection interface 107.

In a case where the present exemplary embodiment is realized by, for example, software, it is not necessary for each block in FIG. 2 to be included in the information processing device.”

The CPU 108 is a system control unit, and comprehensively controls the cloud server 101.

The ROM 102 stores a control program of the CPU 108 and various fixed data.

The RAM 103 includes a static random access memory (SPAM), a dynamic random access memory (DRAM), and other memories. The RAM 103 stores program control variables, various setting parameters, and buffers for various works.

The external storage unit 104 includes a hard disk to store file data such as a document and an image. In the present exemplary embodiment, the external storage unit 104 also stores virtualization software for realizing a function that is the same as a function of a physical computer through software.

The input unit 105 includes a keyboard and a touch panel, and is used by an operator to perform various input operations.

The network connection interface 107 is used for connection to a network. Examples of the connection method include a local area network (LAN) and a universal serial bus (USB).

The cloud server 101 can be configured as a virtual machine, and is activated by loading the virtualization software stored in the external storage unit 104 into the RAM 103.

The cloud browser is executed on the cloud server 101 as the virtual machine.

For example, when the cloud browser receives a rendering request including a uniform resource locator (URL) of a web page from the equipment EQ, the cloud browser accesses an external web server based on the designated URL via the network connection interface 107.

The cloud browser acquires content of the accessed web page, and outputs a result obtained by processing the content as a rendering result to the RAM 103.

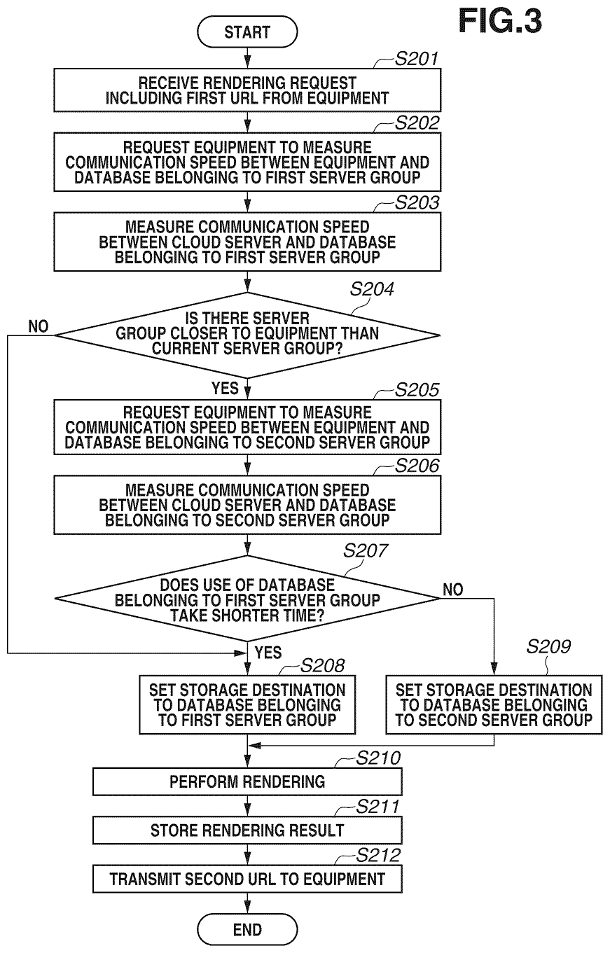

Next, an operation performed by the cloud server 101 according to the first exemplary embodiment is described with reference to FIG. 3 to FIG. 5.

The following description of the operation performed by the cloud server 101 is provided in correspondence to states of the equipment EQ, the first server group SVs1, the second server group SVs2, and other devices described above in conjunction with FIG. 1 for the sake of clarity.

FIG. 3 is a flowchart illustrating the operation performed by the cloud server 101 according to the first exemplary embodiment.

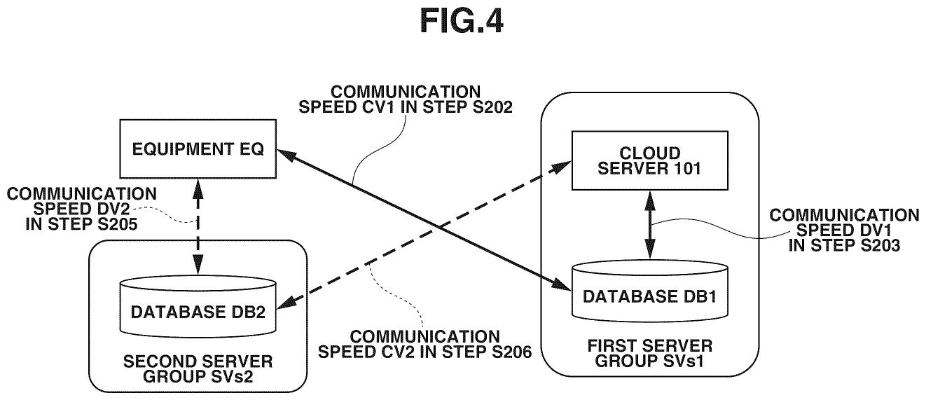

FIG. 4 is a diagram illustrating communication speed to be described in conjunction with the flowchart illustrated in FIG. 3.

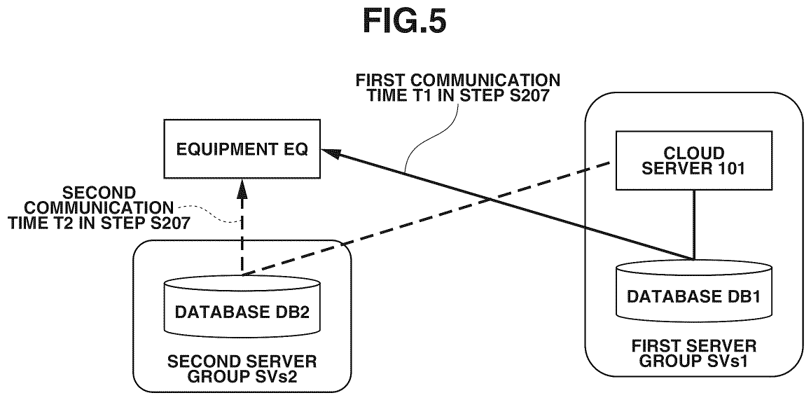

FIG. 5 is a diagram illustrating communication time to be described in conjunction with the flowchart illustrated in FIG. 3.

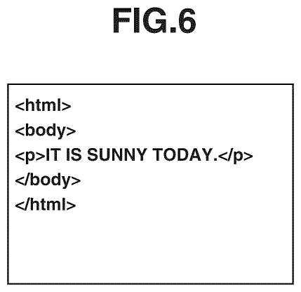

FIG. 6 is a diagram illustrating one example of a hypertext markup language (HTML) to be obtained to perform rendering according to the first exemplary embodiment.

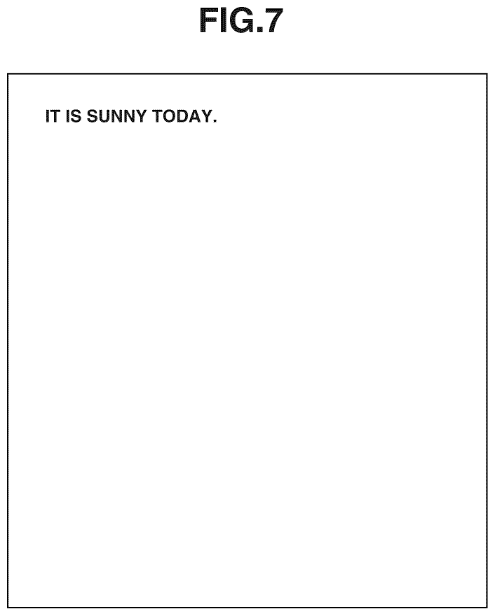

FIG. 7 is a diagram illustrating a rendering result based on the HTML illustrated in FIG. 6.

In particular, the operation performed by the cloud server 101 is described with reference to the flowchart illustrated in FIG. 3.

In step S201, the cloud server 101 receives a rendering request including a first URL of a web page to be rendered from the equipment EQ on which a rendering result is to be displayed, and stores the rendering request in the RAM 103. The rendering request from the equipment EQ is received via the network connection interface 107.

The rendering request may contain information indicating a location of the equipment EQ.

The rendering request may be character string information or binary data.

Moreover, a communication protocol may be a hypertext transfer protocol (HTTP) or hypertext transfer protocol secure (HTTPS).

In step S202, the CPU 108 requests, via the network connection interface 107, the equipment EQ to measure a communication speed CV1 (see FIG. 4) between the equipment EQ and the database DB1 belonging to the first server group SVs1.

The equipment EQ measures the communication speed CV1 (see FIG. 4), and replies to the cloud server 101.

Since the database DB1 is disposed near the cloud server 101, the communication speed between the equipment EQ and the cloud server 101 may be used instead of the communication speed CV1 (see FIG. 4).

For example, a communication speed between the equipment EQ and the cloud server 101 can be calculated based on an HTTP header that has been acquired in step S201, or calculated based on transmission and reception of packets between the cloud server 101 and the equipment EQ via the network connection interface 107.

If a communication speed between the equipment EQ and the cloud server 101 is determined based on the HTTP header, a transmission date and time and a transmission data amount are respectively acquired from the Date header and the Content-Length header, and the communication speed is measured.

In such a case, the CPU 108 may be caused to measure the communication speed based on such an HTTP protocol, thus functioning as a first measurement unit that measures a communication speed based on an HTTP protocol.

In a case where a communication speed between the equipment EQ and the cloud server 101 is determined based on transmission and reception of a packet, packets are transmitted using a transmission control protocol (TCP), and the communication speed is measured.

In such a case, the CPU 108 may be caused to measure the communication speed based on transmission and reception of a packet, thus functioning as a second measurement unit that measures a communication speed based on transmission and reception of a packet.

In step S203, the CPU 108 measures a communication speed DV1 (see FIG. 4) between the cloud server 101 and the database DB1 belonging to the first server group SVs1.

In step S204, the CPU 108 determines whether there is a second server group SVs2 closer to the equipment EQ than the first server group SVs1 to which the cloud server 101 belongs is to the equipment EQ.

A location of the equipment EQ can be acquired from the rendering request or determined from an Internet protocol (IP) address. Alternatively, a location of the equipment EQ can be registered from the equipment EQ beforehand.

If the CPU 108 determines that there is a second server group SVs2 (YES in step S204), the processing proceeds to step S205. If the CPU 108 determines that there is no second server group SVs2 (NO in step S204), the processing proceeds to step S208.

The determination in step S204 includes a selection in which a server group closest to the equipment EQ is set to a second server group SVs2 in a case where there is a plurality of server groups closer to the equipment EQ than the first server group SVs1 is to the equipment EQ.

In step S205, the CPU 108 requests, via the network connection interface 107, the equipment EQ to measure a communication speed DV2 (see FIG. 4) between the equipment EQ and the database DB2 belonging to the second server group SVs2.

The equipment EQ measures the communication speed DV2 (see FIG. 4), and replies to the cloud server 101.

In step S206, the CPU 108 measures a communication speed CV2 (see FIG. 4) between the cloud server 101 and the database DB2 belonging to the second server group SVs2.

In step S207, the CPU 108 calculates a first communication time T1 (see FIG. 5) to be taken in a case where a rendering result is transmitted to the equipment EQ via the database DB1 belonging to the first server group SVs1.

The first communication time T1 is an example of first information in the present exemplary embodiment, and is determined based on a rendering-result data size/(the communication speed DV1+the communication speed CV1). The CPU 108 functions as a first calculation unit that calculates the first information.

In step S207, the CPU 108 calculates a second communication time T2 (see FIG. 5) taken in a case where a rendering result is transmitted to the equipment EQ via the database DB2 belonging to the second server group SVs2.

The second communication time T2 is an example of second information in the present exemplary embodiment, and is determined by a rendering-result data size/(the communication speed DV2+the communication speed CV2). The CPU 108 functions as a second calculation unit that calculates the second information.

In step S207, the CPU 108 determines whether the use of the database DB1 belonging to the first server group SVs1 enables the equipment EQ to acquire a rendering result in a shorter time than in the use of the database DB2.

More specifically, the CPU 108 determines whether the first communication time T1 is shorter than the second communication time T2.

If the CPU 108 determines that the first communication time T1 is shorter than the second communication time T2 (i.e., T1<T2) (YES in step S207), the processing proceeds to step S208. If the CPU 108 determines that the first communication time T1 is not shorter than the second communication time T2 (NO in step S207), the processing proceeds to step S209.

In step S208, the CPU 108 sets a storage destination of the rendering result to the database DB1 belonging to the first server group SVs1.

In step S209, the CPU 108 sets a storage destination of the rendering result to the database DB2 belonging to the second server group SVs2.

As can be appreciated from the descriptions of the operations in steps S207, S208, and S209, the CPU 108 functions as a selection unit that selects a database to use as a storage destination based on the first information and the second information.

In step S210, the CPU 108 acquires content via the network connection interface 107 based on the first URL included in the rendering request, and stores the acquired content in the RAM 103.

The content is data to be used for rendering of a page indicating the first URL. Examples of the content include an HTML, a text, an image, audio, and a moving image.

FIG. 6 illustrates an example of the HTML.

The CPU 108 generates a rendering result based on the content, and stores the rendering result in the RAM 103.

For example, the rendering result based on the HTML illustrated in FIG. 6 is illustrated in FIG. 7.

In step S211, the CPU 108 stores the rendering result in the database that has been set to the storage destination, via the network connection interface 107.

Specifically, if the processing has proceeded to step S208 based on the determination made in step S207, the database DB1 is the storage destination. Accordingly, the rendering result is stored in the database DB1.

On the other hand, if the processing has proceeded to step S209 based on the determination made in step S207, the database DB2 is the storage destination. Accordingly, the rendering result is stored in the database DB2.

Thus, the CPU 108 functions as a storing unit that stores a rendering result in either the database DB1 (also referred to as a first database) or the database DB2 (also referred to as a second database).

The database in which the rendering result has been stored issues a second URL with respect to the rendering result, in other words, a second URL for access to the rendering result which has been stored is issued

The CPU 108 stores the second URL in the RAM 103.

In step S212, the CPU 108 transmits the second URL to the equipment EQ via the network connection interface 107, and the processing performed by the cloud server 101 is ended.

The equipment EQ accesses the database in which the rendering result is stored based on the second URL, and acquires the rendering result. The equipment EQ then updates a user interface UI of the equipment EQ. That is, the equipment EQ displays the rendering result.

For example, if the equipment EQ is a printer, a rendering result is displayed by being printed out or displayed on a screen belonging to the printer.

If the equipment EQ is a PC, a laptop PC, or a digitizing tablet, a rendering result is displayed on a screen thereof.

Typically, a rendering result is stored in a database DB1 belonging to a first server group SVs1 in which a cloud server 101 for providing a cloud browser is arranged.

However, in a case where there is a plurality of server groups, the storing of the rendering result in the database DB1 does not necessarily provide a rendering result at high speed, depending on the location of the equipment EQ.

According to the present exemplary embodiment, a database to be used for storage of a rendering result is determined in view of provision of the rendering result at high speed, with the location of the equipment EQ reflected, so that the rendering result can be provided at high speed.

In the present exemplary embodiment, as illustrated in FIG. 3, the processing is executed when the equipment EQ first transmits a rendering request to the cloud server 101. However, the processing can be executed again when a predetermined threshold value has been reached since a previous rendering request, for example, a certain time period such as 24 hours has elapsed.

In other words, the CPU 108 is caused to function as an elapsed-time calculation unit that calculates time that has elapsed since a rendering request from the equipment EQ, which is a previous request from a client.

Moreover, the CPU 108 may be caused to function as a reselection unit that performs the operations from steps S202 to S209 again to reselect a database if the elapsed time exceeds a threshold value.

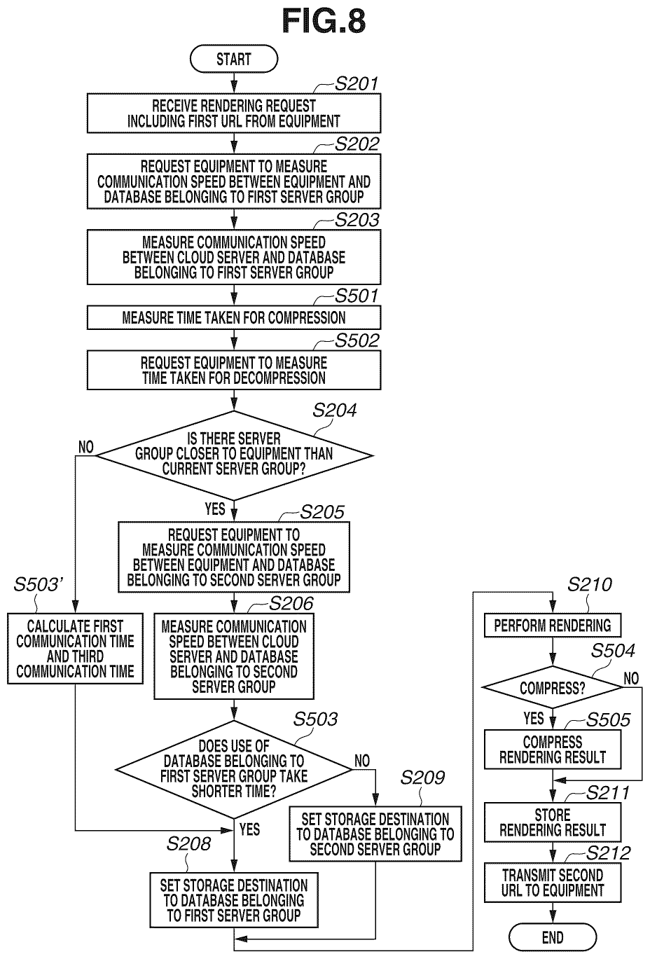

Next, an operation performed by a cloud server 101 according to a second exemplary embodiment is described with reference to FIG. 8.

FIG. 8 is a flowchart illustrating the operation performed by the cloud server 101 according to the second exemplary embodiment.

The second exemplary embodiment and the first exemplary embodiment have similarities. In FIG. 8, steps that are similar in operation to those in FIG. 3 are given the same step numbers as above, and descriptions thereof are understood by referring to the first exemplary embodiment.

Hereinafter, descriptions of differences from the first exemplary embodiment are mainly provided, whereas descriptions of the similarities to the first exemplary embodiment may be omitted.

In step S501, a CPU 108 measures time taken for the cloud server 101 to compress a rendering result.

In step S502, the CPU 108 requests a piece of equipment EQ to measure time taken to decompress the rendering result which has been compressed.

The equipment EQ measures the time, and replies to the cloud server 101.

In step S503, the CPU 108 measures a first communication time T1 and a second communication time T2.

The first communication time T1 and the second communication time T2 are same as the first communication time T1 and the second communication time T2 described in the first exemplary embodiment.

In step S503, the CPU 108 calculates a third communication time to be taken in a case where a rendering result is compressed, the compressed rendering result is transmitted to the equipment EQ via a database DB1 belonging to a first server group SVs1, and the transmitted rendering result is decompressed by the equipment EQ.

More specifically, the third communication time is determined using the same calculation mathematical expression that is used in determination of the first communication time T1. However, the determination of the third communication time differs from that of the first communication time T1 in that a compressed-rendering-result data size is used instead of the rendering-result data size used in calculation of the first communication time T1.

In other words, the CPU 108 functions as a third calculation unit that calculates the first information described in the first exemplary embodiment based on the rendering result the data of which has been compressed.

In step S503, moreover, the CPU 108 calculates a fourth communication time to be taken in a case where a rendering result is compressed, the compressed rendering result is transmitted to the equipment EQ via a database DB2 belonging to a second server group SVs2, and the transmitted rendering result is decompressed by the equipment EQ.

More specifically, the fourth communication time is determined using the same calculation mathematical expression that is used in determination of the second communication time T2. However, the determination of the fourth communication time differs from that of the second communication time T2 in that a compressed-rendering-result data size is used instead of the rendering-result data size used in calculation of the second communication time T2.

In other words, the CPU 108 functions as a fourth calculation unit that calculates the second information described in the first exemplary embodiment based on the rendering result after data compression.

In step S503, furthermore, the CPU 108 determines whether the use of the database DB1 belonging to the first server group SVs1 enables the equipment EQ to acquire a rendering result in a displayable state in a shorter time than in the use of the database DB2, based on the first through fourth communication time.

The term “a rendering result in a displayable state (hereinafter also referred to as a displayable rendering result)” used herein represents data that has undergone up to decompression processing in a case where the equipment EQ receives data as compressed data.

More specifically, if either the first communication time T1 or the third communication time is the shortest time, the CPU 108 determines that the use of the database DB1 belonging to the first server group SVs1 enables the equipment EQ to acquire a displayable rendering result in a shorter time than in the use of the database DB2 (YES in step S503), and the processing proceeds to step S208.

On the other hand, if either the second communication time T2 or the fourth communication time is the shortest time, the processing proceeds to step S209.

Even if the determination result indicates NO in step S204 (NO in step S204), the processing proceeds via step S208. However, the first communication time T1 and the third communication time are to be used for determination in step S504 described below.

Accordingly, if the determination result indicates NO in step S204 (NO in step S204), the processing proceeds to step S503′. In step S503′, the CPU 108 calculates the first communication time T1 and the third communication time. Subsequently, the processing proceeds to step S208.

In step S504, the CPU 108 determines whether to compress the rendering result.

More specifically, if the CPU 108 determines that either the third or fourth communication time is the shortest time (YES in step S504), the processing proceeds to step S505. Otherwise (NO in step S504), the process proceeds to step S211.

In step S505, the CPU 108 compresses the rendering result.

The use of the processing control described in the second exemplary embodiment may enable a rendering result to be displayed at a higher speed than in the first exemplary embodiment.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-216512, filed Dec. 22, 2023, which is hereby incorporated by reference herein in its entirety.

What is claimed is:

1. An information processing apparatus that provides a rendering result for a web page to a client based on a request from the client, the information processing apparatus comprising:
a storing unit configured to store the rendering result in either a first database or a second database different from the first database to provide the rendering result to the client; and
a selection unit configured to select a database to be used as a storage destination of the rendering result by the storing unit, based on first information and second information, the first information being about a duration between the request from the client and provision of the rendering result to the client by use of the first database, and the second information being about a duration between the request from the client and provision of the rendering result to the client by use of the second database.

2. The information processing apparatus according to claim 1, further comprising:
a first calculation unit configured to calculate the first information, based on a communication speed between the information processing apparatus and the first database and a communication speed between the client and the first database; and
a second calculation unit configured to calculate the second information, based on a communication speed between the information processing apparatus and the second database and a communication speed between the client the second database.

3. The information processing apparatus according to claim 2, further comprising a measurement unit configured to measure a communication speed based on a hypertext transfer protocol (HTTP) protocol.

4. The information processing apparatus according to claim 2, further comprising a measurement unit configured to measure a communication speed based on transmission and reception of a packet.

5. The information processing apparatus according to claim 2, further comprising:
an elapsed-time calculation unit configured to calculate elapsed time from a previous request from a client; and
a reselection unit configured to reperform the selection in a case where the elapsed time exceeds a threshold value.

6. The information processing apparatus according to claim 1, further comprising:
a first calculation unit configured to calculate the first information, based on time to be taken to compress the rendering result, a communication speed between the information processing apparatus and the first database, a communication speed between the client and the first database, and time to be taken to decompress the rendering result after compression; and
a second calculation unit configured to calculate the second information, based on time to be taken to compress the rendering result, a communication speed between the information processing apparatus and the second database, a communication speed between the client and the second database, and time to be taken to decompress the rendering result after compression.
